(19) United States
(12) Patent Application Publication
(10) Pub. No.: US 2017/0145835 A1
(43) Pub. Date: May 25, 2017

(54) TURBINE AIRFOIL COOLING SYSTEM WITH BIFURCATED MID-CHORD COOLING CHAMBER

(71) Applicant: SIEMENS AKTIENGESELLSCHAFT, München (DE)

(72) Inventors: Samuel J. Miller, JR., Port St. Lucie, FL (US); Jan H. Marsh, Orlando, FL (US)

(73) Assignee: SIEMENS AKTIENGESELLSCHAFT, München (DE)

(21) Appl. No.: 15/322,186

(22) PCT Filed: Aug. 7, 2014
(86) PCT No.: PCT/US2014/050135

§ 371 Date: Dec. 27, 2016

(51) Int. Cl. F01D 5/18

(52) U.S. Cl. CPC F01D 5/187; F05D 2260/202; F05D 2260/2214; F05D 2250/185

(57) ABSTRACT

A cooling system (10) for a turbine airfoil (12) of a gas turbine engine having a bifurcated mid-chord cooling chamber (16) for cooling the airfoil (26) is disclosed. The bifurcated mid-chord cooling chamber (16) may be formed from a pressure side serpentine cooling channel (18) and a suction side serpentine cooling channel (20) with cooling fluids passing through the pressure side serpentine cooling channel (18) in a direction from the trailing edge (22) toward the leading edge (24) and in an opposite direction through the suction side serpentine cooling channel (20), thereby creating a counterflow system. The counterflow cooling scheme allows for better fine tuning of internal heat transfer which leads to more uniform temperature distributions than conventional systems. Furthermore, in at least one embodiment, the cooling fluids are only exhausted at the trailing edge (22) and not through film cooling holes throughout the cooling system (10), thereby making better use of the cooling fluids and forming a more efficient cooling system (10).

### FIELD OF THE INVENTION

This invention is directed generally to turbine blades, and more particularly to cooling systems in hollow turbine blades.

### BACKGROUND

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine airfoils, including turbine blades and turbine vanes, must be made of materials capable of withstanding such high temperatures. In addition, turbine airfoils often contain cooling systems for prolonging the life of the blades and reducing the likelihood of failure as a result of excessive temperatures.

Early stage turbine vane cooling has mostly been achieved through use of impingement and film cooling, but such cooling schemes have only yielded low thermal efficiencies. Although standard impingement and film cooling schemes provide ample cooling, the coolant air consumption is too high because air is often ejected out of the airfoil before the full cooling capacity of the air has been reached. A significant challenge that is present with convective cooling of early stage turbine vanes is that it is difficult to obtain the necessary internal heat transfer coefficients required to cool the component with low enough pressure drop and without the use of impingement cooling or film cooling.

### SUMMARY OF THE INVENTION

A cooling system for a turbine airfoil of a gas turbine engine having a bifurcated mid-chord cooling chamber for reducing the temperature of the airfoil is disclosed. The bifurcated mid-chord cooling chamber may be formed from a pressure side serpentine cooling channel and a suction side serpentine cooling channel with cooling fluids passing through the pressure side serpentine cooling channel in a direction from the trailing edge toward the leading edge and in an opposite direction through the suction side serpentine cooling channel, thereby creating a counterflow system. The counterflow cooling scheme allows for better fine tuning of internal heat transfer which leads to more uniform temperature distributions than conventional systems. Furthermore, in at least one embodiment, the cooling fluids are only exhausted at the trailing edge and not through film cooling holes throughout the cooling system, thereby making better use of the cooling fluids and forming a more efficient cooling system.

In at least one embodiment, the turbine airfoil may be formed from a generally elongated hollow airfoil formed from an outer wall, and having a leading edge, a trailing edge, a pressure side, a suction side, an inner endwall at a first end and an outer endwall at a second end that is generally on an opposite side of the generally elongated hollow airfoil from the first end, and a cooling system positioned within interior aspects of the generally elongated hollow airfoil. The cooling system may include an upstream flowing pressure side serpentine cooling channel having an inlet for receiving cooling fluids from a cooling fluid source such that the inlet is attached to a first leg that is between a second leg and the trailing edge of the airfoil. The upstream flowing pressure side serpentine cooling channel may include an exhaust outlet in fluid communication with an inlet of a downstream flowing suction side serpentine cooling channel via a spanwise extending midchord forward collection channel extending from an outer wall forming the pressure side to an outer wall forming the suction side and extending spanwise from the exhaust outlet of the upstream flowing pressure side serpentine cooling channel to the inlet of the downstream flowing suction side serpentine cooling channel. The downstream flowing suction side serpentine cooling channel may be positioned at the suction side of the airfoil and opposite to the upstream flowing pressure side serpentine cooling channel. The cooling fluid in the suction side serpentine cooling channel flows generally spanwise back and forth and generally downstream towards the trailing edge, thereby forming cooling fluid counterflow between the pressure side and suction side serpentine cooling channels.

The downstream flowing suction side serpentine cooling channel may include one or more exhaust outlets in communication with an aft collection chamber. The aft collection chamber may extend from the outer wall forming the pressure side to the outer wall forming the suction side and may be positioned between a rib forming a downstream end of the pressure side and suction side serpentine cooling channels and a trailing edge cooling channel.

The exhaust outlet of the upstream flowing pressure side serpentine cooling channel may be positioned at an opposite end in a spanwise direction from the inlet of the downstream flowing suction side serpentine cooling channel within the forward collection channel. The exhaust outlet of the upstream flowing pressure side serpentine cooling channel may be positioned at a spanwise outer end, and the downstream flowing suction side serpentine cooling channel may be positioned at a spanwise inner end within the forward collection channel. In at least one embodiment, the pressure side serpentine cooling channel in contact with the pressure side outer wall may be a double pass serpentine cooling channel, and the suction side serpentine cooling channel in contact with the suction side outer wall may be a double pass serpentine cooling channel.

The cooling system may also include one or more leading edge supply chambers extending spanwise positioned between the leading edge of the generally elongated airfoil and a rib defining at least a portion of the forward collection channel. The leading edge supply chamber and the forward collection channel may be separated by a rib, thereby preventing cooling fluid movement between the leading edge supply chamber and the forward collection channel. The cooling system may also include one or more trailing edge cooling channels extending from the outer wall forming the pressure side to the outer wall forming the suction side and between the trailing edge of the generally elongated hollow airfoil and the aft collection chamber. One or more aft collection chamber exhaust orifices may be positioned in a rib and extend from the aft collection chamber to the trailing edge cooling channel. One or more trailing edge exhaust orifices may be positioned at the trailing edge of the generally elongated hollow airfoil and extend from the trailing edge cooling channel to exhaust cooling fluids through the trailing edge.

During use, cooling fluids may be passed from a cooling fluid supply such as, but not limited to, a compressor, into the first leg of the pressure side serpentine cooling channel via the inlet. A portion of the cooling fluids may enter the pressure side serpentine cooling channel, and a portion of the cooling fluids may enter the leading edge supply chamber. The cooling fluids in the pressure side serpentine cooling channel may flow through the first and second legs of the pressure side serpentine cooling channel absorbing heat from the surfaces of the legs formed, in part, by the pressure sidewall and a mid-chord rib. The cooling fluids pass through the pressure side serpentine cooling channel and move in a direction generally from the trailing edge toward the leading edge.

After passing through the pressure side serpentine cooling channel, the cooling fluids pass through the exhaust outlet into the forward collection channel. The cooling fluids collect in the forward collection channel at the spanwise outer end and travel to the spanwise inner end where the cooling fluids are exhausted into the inlet of the downstream flowing suction side serpentine cooling channel. The cooling fluids flow through the suction side serpentine channel generally chordwise and in a direction generally downstream from the leading edge towards the trailing edge. The cooling fluids may be exhausted from the suction side serpentine channel through the one or more exhaust outlets into the aft collection chamber. The cooling fluids may flow through the aft collection chamber and be exhausted through one or more aft collection chamber exhaust orifices and into the trailing edge cooling channel, wherein the cooling fluids may be exhausted through one or more trailing edge exhaust orifices.

The cooling system of the turbine airfoil is advantageous for numerous reasons. In particular, the bifurcated mid-chord cooling chamber increases the efficiency of the turbine blade cooling system in the turbine blade. For instance, the bifurcated mid-chord cooling chamber enables the overall cooling flow requirement to be reduced by enabling the cooling system proximate to the pressure sidewall to be tailored based on heating load. The bifurcated mid-chord cooling chamber also enables high aspect ratio flow channels to be used, reduces the difficulty of installing film cooling holes, and increases the ratio of hot wall length to cross-sectional flow area allowing similar heat transfer coefficients with less flow producing a more efficient design. The aspect ratio may be a ratio of width to height. The bifurcated mid-chord cooling chamber also eliminates design issues, such as back flow margin (BFM) and high blowing ratio, that are typical for suction side film cooling holes in conventional designs. The bifurcated mid-chord cooling chamber enables control of the cross-sectional area, aspect ratio heat transfer augmentation features and upstream coolant heat up by routing flow differently, if needed, which leads to more uniform metal temperature, which is beneficial. The bifurcated mid-chord cooling chamber may also utilize a single cooling flow circuit with passages that are of smaller cross-sectional area, leading to higher coolant velocities even at low flow rates, yielding higher internal convective cooling performance than a conventional mid-chord serpentine cooling channel.

Another advantage of the cooling system is that the system may substantially reduce, if not eliminate, the need for impingement or film cooling in the airfoil.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a turbine airfoil including the cooling system.

FIG. 2 is a cross-sectional view of the turbine airfoil taken along section line 2-2 in FIG. 1.

FIG. 3 is a cross-sectional view of the turbine airfoil shown in FIG. 1 taken along section line 3-3 in FIG. 1.

FIG. 4 is a perspective view of the cooling channels within the turbine airfoil taken from the outer diameter looking inward, such as from section line 2-2 in FIG. 2 looking inward.

FIG. 5 is a perspective view of the cooling channels within the turbine airfoil taken from the inner diameter looking outward, such as from section line 3-3 in FIG. 2 looking outward.

FIG. 6 is a cross-sectional, filleted view of the cooling channels within the turbine airfoil taken along section line 6-6 in FIG. 4.

FIG. 7 is a cross-sectional, filleted view of the cooling channels within the turbine airfoil taken along section line 7-7 in FIG. 5.

### DETAILED DESCRIPTION OF THE INVENTION

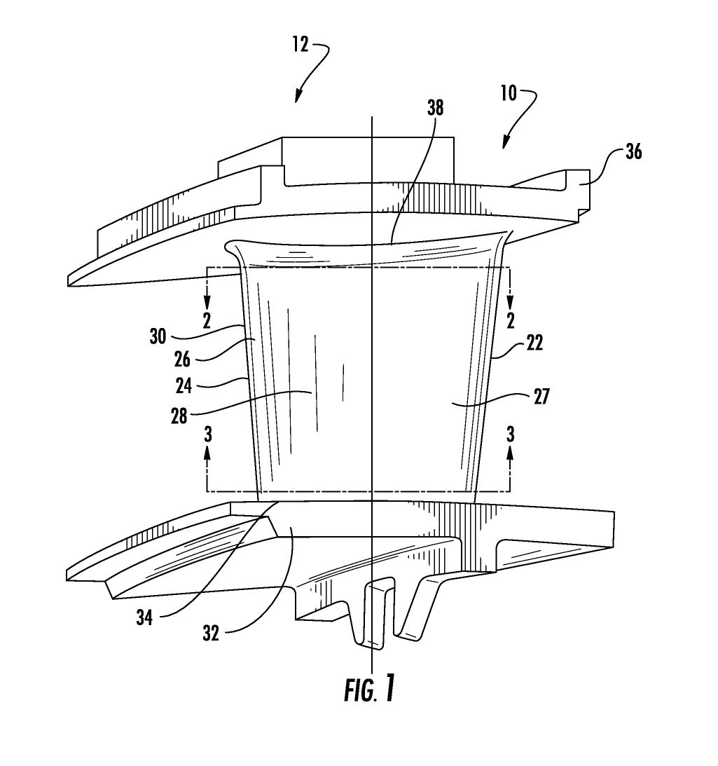

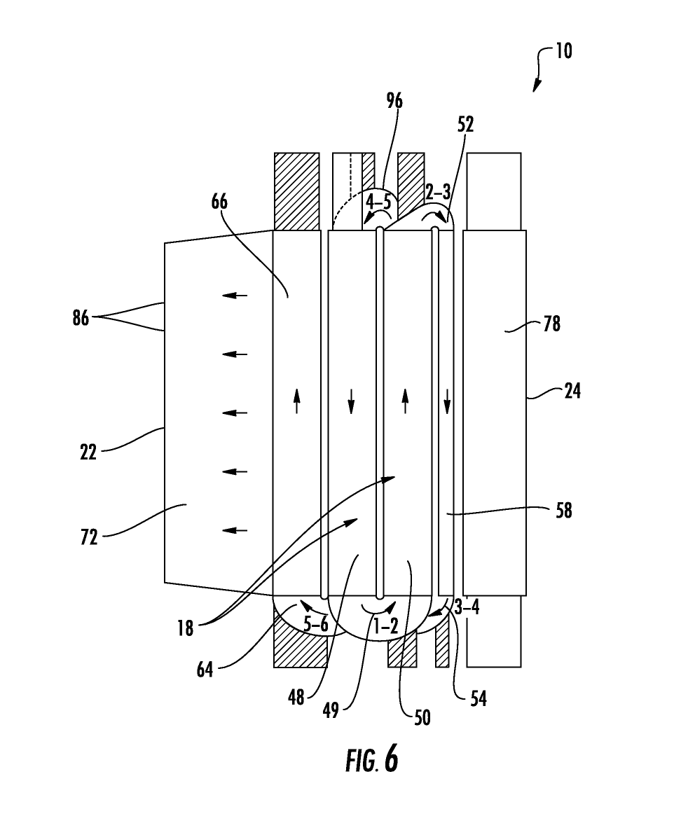

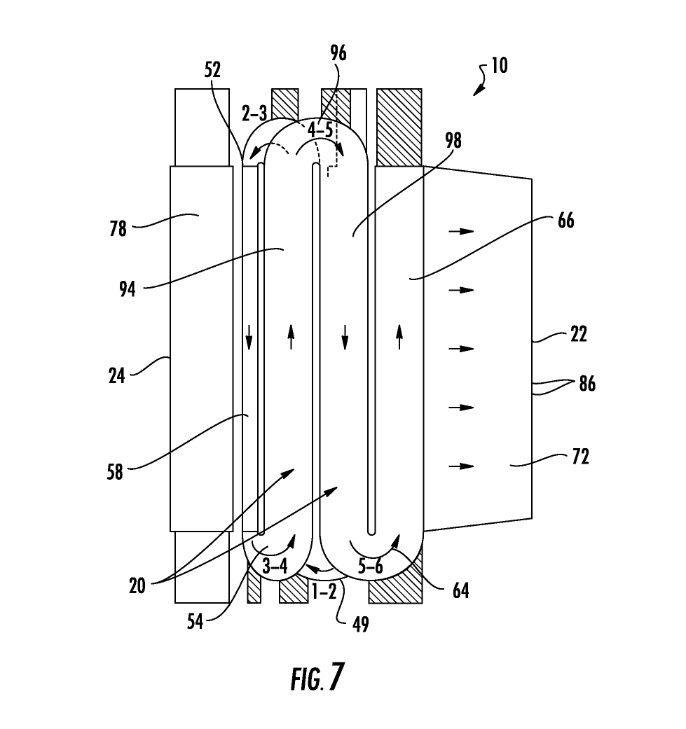

As shown in FIGS. 1-7, a cooling system 10 for a turbine airfoil 12 of a gas turbine engine having a bifurcated mid-chord cooling chamber 16 for reducing the temperature of the airfoil 12 is disclosed. The bifurcated mid-chord cooling chamber 16 may be formed from a pressure side serpentine cooling channel 18 and a suction side serpentine cooling channel 20 with cooling fluids passing through the pressure side serpentine cooling channel 18 in a direction from the trailing edge 22 toward the leading edge 24 and in an opposite direction through the suction side serpentine cooling channel 20, thereby creating a counterflow system. The counterflow cooling scheme 10 allows for better fine tuning of internal heat transfer which leads to more uniform temperature distributions than conventional systems. Furthermore, in at least one embodiment, the cooling fluids are only exhausted at the trailing edge 22 and not through film cooling holes throughout the cooling system 10, thereby making better use of the cooling fluids and forming a more efficient cooling system.

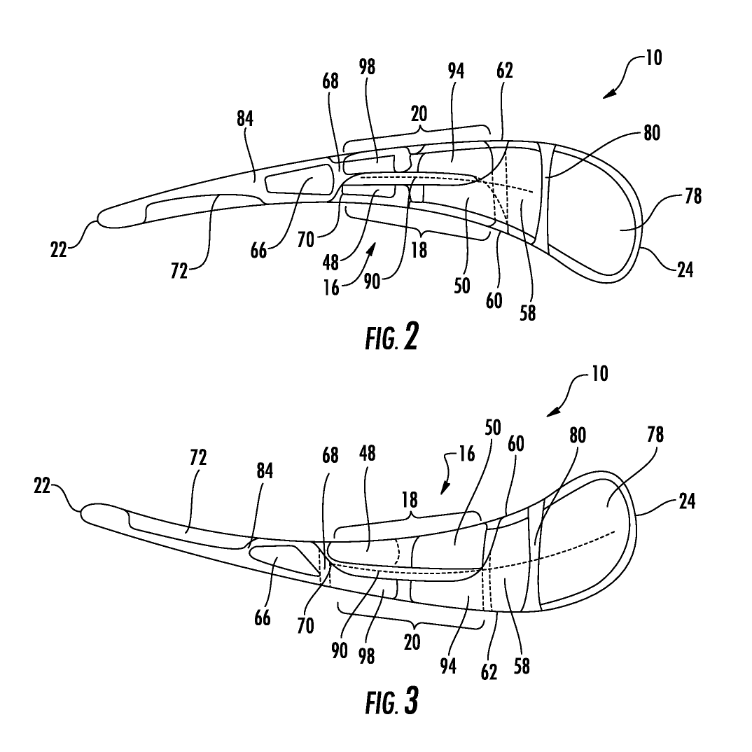

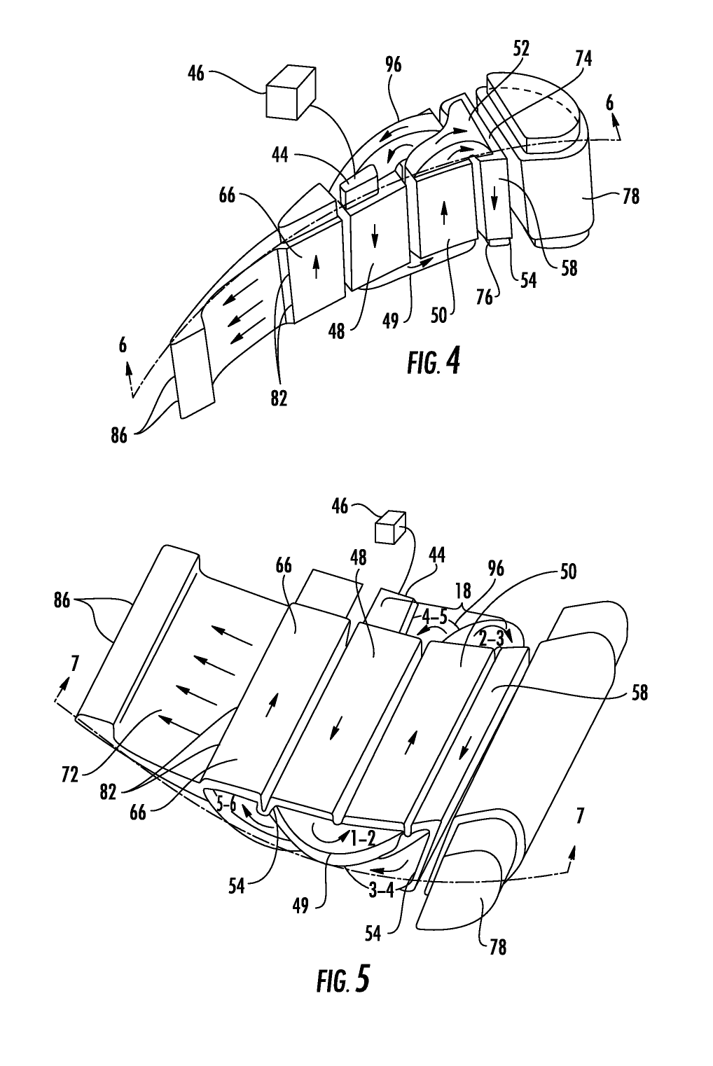

In at least one embodiment, as shown in FIG. 1, the turbine airfoil 12 may be formed from a generally elongated hollow airfoil 26 formed from an outer wall 27, and having a leading edge 24, a trailing edge 22, a pressure side 28, a suction side 30, an inner endwall 32 at a first end 34 and an outer endwall 36 at a second end 38 that is generally on an opposite side of the generally elongated hollow airfoil 26 from the first end 34, and a cooling system 10 positioned within interior aspects of the generally elongated hollow airfoil 26. As shown in FIGS. 2-7, the cooling system 10 may include an upstream flowing pressure side serpentine cooling channel 18 having an inlet 44 for receiving cooling fluids from a cooling fluid source 46 such that the inlet 44 is attached to a first leg 48 that is between a second leg 50 and the trailing edge 22 of the airfoil 26. The first leg 48 and the second leg 50 may be coupled together via first pressure side turn 49, as shown in FIGS. 4-7. The upstream flowing pressure side serpentine cooling channel 18 may include an exhaust outlet 52 in fluid communication with an inlet 54 of a downstream flowing suction side serpentine cooling channel 20 via a spanwise extending midchord forward collection channel 58 extending from an outer wall 60 forming the pressure side 26 to an outer wall 62 forming the suction side 30 and extending spanwise from the exhaust outlet 52 of the upstream flowing pressure side serpentine cooling channel 18 to the inlet 54 of the downstream flowing suction side serpentine cooling channel 20. The downstream flowing suction side serpentine cooling channel 20 may be positioned at the suction side 30 of the airfoil 26 and opposite to the upstream flowing pressure side serpentine cooling channel 18.

The cooling fluid flow through the suction side serpentine cooling channel 20 flows generally spanwise back and forth and generally downstream towards the trailing edge 22, thereby forming cooling fluid counterflow between the pressure side and suction side serpentine cooling channels 18, 20. The cooling fluid may flow in a spanwise inner direction through suction side serpentine cooling channel leg one 94, may pass through suction side turn one 96 and into suction side serpentine cooling channel leg two 98, as shown in FIGS. 2-4.

The downstream flowing suction side serpentine cooling channel 20 may include one or more exhaust outlets 64 in communication with an aft collection chamber 66. The aft collection chamber 66 may extend from the outer wall 60 forming the pressure side 28 to the outer wall 62 forming the suction side 62 and may be positioned between a rib 68 forming a downstream end 70 of the pressure side and suction side serpentine cooling channels 18, 20 and a trailing edge cooling channel 72.

The exhaust outlet 64 of the upstream flowing pressure side serpentine cooling channel 18 may be positioned at an opposite end in a spanwise direction from the inlet 54 of the downstream flowing suction side serpentine cooling channel 20 within the forward collection channel 58. The exhaust outlet 52 of the upstream flowing pressure side serpentine cooling channel 18 may be positioned at a spanwise outer end 74, and the downstream flowing suction side serpentine cooling channel 20 may be positioned at a spanwise inner end 76 within the forward collection channel 58. In at least one embodiment, the pressure side serpentine cooling channel 18 in contact with the pressure side outer wall 60 may be, but is not limited to being, a double pass serpentine cooling channel. Similarly, the suction side serpentine cooling channel 20 in contact with the suction side outer wall 62 may be, but is not limited to being, a double pass serpentine cooling channel.

The internal cooling system 10 may also include a leading edge supply chamber 78 extending spanwise and positioned between the leading edge 24 of the generally elongated airfoil 26 and a rib 80 defining at least a portion of the forward collection channel 58. The leading edge supply chamber 78 and the forward collection channel 58 may be separated by the rib 80, thereby preventing cooling fluid movement between the leading edge supply chamber 78 and the forward collection channel 58. The leading edge supply chamber 78 may have any appropriate configuration.

The internal cooling system 10 may also include one or more trailing edge cooling channels 72 extending from the outer wall 60 forming the pressure side 28 to the outer wall 62 forming the suction side 30 and between the trailing edge 22 of the generally elongated hollow airfoil 26 and the aft collection chamber 66. One or more aft collection chamber exhaust orifices 82 may be positioned in a rib 84 and extending from the aft collection chamber 66 to the trailing edge cooling channel 72. One or more trailing edge exhaust orifices 86 may be positioned at the trailing edge 22 of the generally elongated hollow airfoil 26 and extending from the trailing edge cooling channel 72 to exhaust cooling fluids through the trailing edge 22.

During use, cooling fluids may be passed from a cooling fluid supply 46 such as, but not limited to, a compressor, into the first leg 48 of the pressure side serpentine cooling channel 18 via the inlet 44. A portion of the cooling fluids enter the pressure side serpentine cooling channel 18, and a portion of the cooling fluids may enter the leading edge supply chamber 78. The cooling fluids in the pressure side serpentine cooling channel 18 may flow through the first and second legs 48, 50 of the pressure side serpentine cooling channel 18 absorbing heat from the surfaces of the legs 48, 50 formed, in part, by the pressure sidewall 60 and a mid-chord rib 90. The cooling fluids pass through the pressure side serpentine cooling channel 18 and move in a direction generally from the trailing edge 22 toward the leading edge 24.

After passing through the pressure side serpentine cooling channel 18, the cooling fluids pass through the exhaust outlet 52 into the forward collection channel 58. The cooling fluids collect in the forward collection channel 58 at the spanwise inner end 74 and travel to the spanwise outer end 76 where the cooling fluids are exhausted into the inlet 54 of the downstream flowing suction side serpentine cooling channel 20. The cooling fluids flow through the suction side serpentine channel 20 generally chordwise and in a direction generally downstream from the leading edge 24 towards the trailing edge 22. The cooling fluids may be exhausted from the suction side serpentine channel 20 through the one or more exhaust outlets 64 into the aft collection chamber 66. The cooling fluids may flow through the aft collection chamber 66 and be exhausted through one or more aft collection chamber exhaust orifices 82 and into the trailing edge cooling channel 72, wherein the cooling fluids may be exhausted through one or more trailing edge exhaust orifices 86.

The foregoing is provided for purposes of illustrating, explaining, and describing embodiments of this invention. Modifications and adaptations to these embodiments will be apparent to those skilled in the art and may be made without departing from the scope or spirit of this invention.

1. A turbine airfoil comprising:
a generally elongated hollow airfoil formed from an outer wall, and having a leading edge, a trailing edge, a pressure side, a suction side, an inner endwall at a first end and an outer endwall at a second end that is generally on an opposite side of the generally elongated hollow airfoil from the first end, and a cooling system positioned within interior aspects of the generally elongated hollow airfoil;
wherein the cooling system includes an upstream flowing pressure side serpentine cooling channel having an inlet for receiving cooling fluids from a cooling fluid source such that the inlet is attached to a first leg that is between a second leg and the trailing edge of the airfoil and wherein the upstream flowing pressure side serpentine cooling channel includes an exhaust outlet in fluid communication with an inlet of a downstream flowing suction side serpentine cooling channel via a spanwise extending midchord forward collection channel extending from an outer wall forming the pressure side to an outer wall forming the suction side and extending spanwise from the exhaust outlet of the upstream flowing pressure side serpentine cooling channel to the inlet of the downstream flowing suction side serpentine cooling channel;
wherein the downstream flowing suction side serpentine cooling channel is positioned at the suction side of the airfoil and opposite to the upstream flowing pressure side serpentine cooling channel, wherein the cooling fluid flow through the suction side serpentine cooling channel flows generally spanwise back and forth and generally downstream towards the trailing edge, thereby forming cooling fluid counterflow between the pressure side and suction side serpentine cooling channels; and
wherein the downstream flowing suction side serpentine cooling channel includes at least one exhaust outlet in communication with an aft collection chamber.

2. The turbine airfoil of claim 1, wherein the aft collection chamber extends from the outer wall forming the pressure side to the outer wall forming the suction side and is positioned between a rib forming a downstream end of the pressure side and suction side serpentine cooling channels and a trailing edge cooling channel.

3. The turbine airfoil of claim 1, wherein the exhaust outlet of the upstream flowing pressure side serpentine cooling channel is positioned at an opposite end in a spanwise direction from the inlet of the downstream flowing suction side serpentine cooling channel within the forward collection channel.

4. The turbine airfoil of claim 3, wherein the exhaust outlet of the upstream flowing pressure side serpentine cooling channel is positioned at a spanwise outer end, and the downstream flowing suction side serpentine cooling channel is positioned at a spanwise inner end within the forward collection channel.

5. The turbine airfoil of claim 1, wherein the pressure side serpentine cooling channel in contact with the pressure side outer wall is a double pass serpentine cooling channel.

6. The turbine airfoil of claim 1, wherein the suction side serpentine cooling channel in contact with the suction side outer wall is a double pass serpentine cooling channel.

7. The turbine airfoil of claim 1, further wherein a leading edge supply chamber extending spanwise and positioned between the leading edge of the generally elongated airfoil and a rib defining at least a portion of the forward collection channel.

8. The turbine airfoil of claim 1, further wherein at least one trailing edge cooling channel extending from the outer wall forming the pressure side to the outer wall forming the suction side and between the trailing edge of the generally elongated hollow airfoil and the aft collection chamber.

9. The turbine airfoil of claim 8, further wherein at least one aft collection chamber exhaust orifice positioned in a rib and extending from the aft collection chamber to the trailing edge cooling channel.

10. The turbine airfoil of claim 8, further wherein at least one trailing edge exhaust orifice positioned at the trailing edge of the generally elongated hollow airfoil and extending from the trailing edge cooling channel to exhaust cooling fluids through the trailing edge.

11. The turbine airfoil of claim 1, wherein a leading edge supply chamber and the forward collection channel are separated by a rib, thereby preventing cooling fluid movement between the leading edge supply chamber and the forward collection channel.
